(19) United States
(12) Patent Application Publication
(10) Pub. No.: US 2025/0024820 A1
(43) Pub. Date: Jan. 23, 2025

(54) DEVICE FOR THE PROLIFERATION OF UNDERWATER BIODIVERSITY

(71) Applicant: OCEAN ECOSTRUCTURES S.L., BARCELONA (ES)

(72) Inventors: Ignacio FERRER PELLICER, BARCELONA (ES); Mireia DE MAS ROMEU, BARCELONA (ES)

(21) Appl. No.: 18/715,688

(22) PCT Filed: Dec. 2, 2022
(86) PCT No.: PCT/IB2022/061693

§ 371 Date: May 31, 2024

(30) Foreign Application Priority Data
Dec. 3, 2021 (EP) 21383095.3

(51) Int. Cl. A01K 61/73

(52) U.S. Cl. CPC A01K 61/73

(57) ABSTRACT

A device for the proliferation of underwater biodiversity that includes a shield structure having one or more walls configured to define one or more internal compartments at least partially extending along a first direction. One or more of the walls of the shield structure is a metal wall, or a wall made of a biocompatible material, including a plurality of holes. One or more of the internal compartments may include two respective end portions, which are distantly arranged. The device is configured such that at least one of the end portions of the one or more compartments is configured to be at least partially free of the one or more walls of the shield structure, thereby defining at least one opening.

### FIELD OF THE INVENTION

The present invention is concerned with a device and a system for promoting the proliferation of underwater biodiversity. In particular, the invention comprises a plurality of characteristics configured to provide enhanced living conditions for a variety of underwater biodiversity.

### BACKGROUND OF THE INVENTION

Currently known devices for promoting the proliferation of biodiversity are mainly focused either on specifically promoting animal biodiversity proliferation, or on specifically promoting the proliferation of vegetal underwater biodiversity and/or of sessile underwater biodiversity/organisms (e.g., algae, coral, sessile benthonic organisms). In biology, a sessile organism is an organism without means of self-locomotion. Sessile organisms can move via external forces (such as water currents), but are usually permanently attached to something. However, prior art devices present some well-known inconveniences.

Known devices for promoting the proliferation of animal underwater biodiversity are primarily configured to provide a cage structure to protect the animal underwater biodiversity (e.g., juvenile fish or post-larvae of fish, i.e. animal biodiversity that has yet to grow and develop) from their natural predators. Such devices therefore promote the survival of aquatic organisms in the early stages of their lives by providing them with a safe volume. Juvenile fish must be allowed to enter and leave the device through the walls (e.g., through specific holes provided on the walls) of the cage structure. The walls are configured to allow the access of the juvenile fish, while preventing the entrance of potential predators.

Therefore, the proliferation of underwater vegetal biodiversity and/or the proliferation of sessile underwater biodiversity on the walls of the prior art cage structure is an undesired effect, since it will prevent the juvenile fish from entering and exiting the device. Consequently, a disadvantage of such prior art devices that do not have proliferation of underwater vegetal biodiversity and/or sessile underwater organisms on its walls is that potential predators, having a size that does not allow them to enter into the cage structure of the device, are allowed to detect, watch and monitor the juvenile fish, waiting until the moment they leave the cage for attacking them. This effect sometimes causes that a significant number of predators are attracted to the device, therefore increasing the risk for the juvenile fish.

Said prior art solutions are merely configured to allow the entrance and exit of juvenile fish into an inner closed volume of the device via respective holes arranged on the walls of the device. Hence, said devices are not specifically designed or indicated for promoting the proliferation of animal biodiversity, while simultaneously promoting the proliferation of underwater vegetal biodiversity and/or of sessile underwater organisms

Known devices for promoting the proliferation of underwater vegetal biodiversity and/or of sessile underwater biodiversity include the use of stainless-steel structures configured to promote the proliferation of some particular algae, or even for cultivating coral. This second kind of prior art devices merely provide a structural support configured to be completely covered by such underwater vegetal biodiversity and/or sessile underwater biodiversity, but fails to provide any kind of physical protection for protecting animal biodiversity from potential predators. When such type of prior art devices comprise walls configured to surround a volume, the proliferation of underwater vegetal biodiversity and/or of sessile underwater biodiversity on the walls of the device causes any animal biodiversity (e.g. juvenile fish or post-larvae of fish) to be prevented from entering or leaving the volume, since the volume remains inaccessible, and therefore cannot be used for providing a safe environment to animal underwater biodiversity.

Therefore, there is room for technical improvement regarding devices for the proliferation of underwater biodiversity.

### SUMMARY OF THE INVENTION

The present invention addresses the problem of providing means for promoting the proliferation of underwater biodiversity; in particular a device for simultaneously and actively promoting the proliferation of animal biodiversity and promoting the proliferation of vegetal biodiversity and/or sessile underwater biodiversity around/over the device. This problem is solved by a device according to claim 1. Preferred embodiments of the invention are defined in the appended dependent claims.

A first aspect of the invention refers to a device that comprises a shield structure comprising one or more walls, wherein said walls define one or more internal compartments at least partially extending along a first direction. The one or more walls may at least comprise a primary wall configured as a front outer wall and a secondary wall. Each of the one or more internal compartments may be arranged between the primary wall and the secondary wall.

One or more of the walls (preferably, at least the primary wall and/or at least the secondary wall) may be made of metal or ceramic or glass foam. In preferred embodiments, one or more of the walls are made of material comprising calcic carbonate (e.g., a ceramic or a metal comprising calcic carbonate) and/or are made of a material being a biocompatible material. Independently of the material selected, the one or more walls may further comprise a plurality of holes, preferably of a plurality of sizes. In the context of the current invention, a biocompatible material refers to a material suitable for (compatible with) living organisms (e.g., animal biodiversity and/or vegetal underwater biodiversity and/or sessile underwater biodiversity/organisms) to proliferate in contact with said material.

The biocompatible material may be configured as a glass foam or as a material comprising calcium carbonate (CaCO₃). The material comprising calcium carbonate may be a metal or a ceramic comprising calcium carbonate. The metal material may be a low-carbon steel or a medium-carbon steel, wherein mild steel is a preferred option (carbon content of 0.05-0.30%). Thus, the metal material may be a steel, such as a steel with a carbon content in the range 0.05-0.5%, preferably in the range 0.16-0.29%, and more preferably in the range 0.24-0.27%.

In some embodiments the substrate may be configured as a ceramic material comprising calcic carbonate. The ceramic material may be a refractory clay. In some embodiments the shield structure is integrally made of the described materials or a combination thereof.

The material comprising calcium carbonate may be configured as substrate comprising calcium carbonate, such as a metal substrate or a ceramic substrate comprising an external layer (e.g., a coating or covering) of calcium carbonate (e.g., obtained, in the case of the metal substrate by means of an electrolysis method). It is noted than one or more of the walls may be connected to each other before generating a layer of calcium carbonate, such that a single process for generating an external layer of calcium carbonate (e.g., an electrolysis process for metals) may be conducted for all the connected walls at the same time, thereby obtaining a calcium/calcic carbonated monoblock (i.e., single body structure with a monolithic configuration) structure.

One or more of the internal compartments may comprise two respective end portions, and may extend longitudinally between its respective end portions (thus, defining a longitudinal direction), which are distantly/distally arranged (i.e., separated by a length of the respective internal compartment). In some embodiments, the respective end portions of an internal compartment may be oppositely arranged one to each other. It is noted that the so-called first direction is a reference direction, not necessarily coinciding with the longitudinal direction of the internal compartments, although is some cases both directions may be coincidentally arranged.

One or more of the internal compartments may extend longitudinally (i.e. along the direction defined between its two respective end portions) following a straight path or a curved path or a combination thereof.

Hence, one or more of the internal compartments may at least partially extend longitudinally, along the first direction. Thus, at least one of the components of a vector defining the first direction may coincide with, or be parallel to, one of the components of a vector defining a longitudinal direction of an internal compartment. In some embodiments, the first direction may be a first substantially horizontal direction.

One or more of the internal compartments may comprise a constant or a variable cross-section area along its longitudinal extension. The internal compartment or internal compartments having a variable cross-section may be configured such that the area of the cross-section in the end portions having an opening is smaller than the areas of the rest of cross-sections along the longitudinal extension of the referred compartment(s). This has the advantage of providing the animal biodiversity with a bigger living volume/space, while the area of the end portions having an opening is reduced, thereby reducing the risk of predators entering into the compartment.

The interaction of metal walls (especially metal walls not being configured to be rustproof) with the water of a subaquatic/underwater environment (especially with salt water in a sea or an ocean) generates a substrate that is particularly suitable for allowing the adhesion of underwater vegetal biodiversity and/or of sessile underwater biodiversity.

The primary wall may be configured in some embodiments as a front wall of the device (i.e., the device may be installed in a position such that the primary wall is arranged in the front of the device, e.g. being configured as an external skin of the device) while the secondary wall may be configured as rear wall, or as a wall configured to separate the shelter structure from the rest of the device. When the secondary wall is configured as a rear wall, the secondary wall may further comprise fixation/attachment means configured to fix/attach/connect the device to an auxiliary subaquatic structure external to the device. The attachment means may be configured, for example, as chains and/or clamps. The aim of such attachment means is to provide the necessary clamping or attaching force, so as to hold the device in its position without allowing a substantial movement or displacement of the device. In preferred embodiments, the attaching means are configured to be attached to the auxiliary external structure, such that the device is hanging from the auxiliary external structure without being standing or resting on a ground or floor.

The one or more internal compartments of the shield structure may be arranged between the primary wall and the secondary wall. In some embodiments, the primary wall and the secondary wall may be configured as two independent walls or as two differentiated parts of a single bent wall (i.e. folded on itself). In some embodiments, the primary wall and/or the secondary wall and/or any wall of the shield structure may be configured as a combination of overlapping o laterally interconnected sub-walls

In preferred embodiments of the invention, at least one of the one or more walls (preferably at least the primary wall) may be configured to have a roughened surface and/or to comprise a plurality of holes, preferably of a plurality of sizes. A rough/roughened surface (i.e., a surface not being smooth) allows the proliferation of underwater vegetal biodiversity and/or of sessile underwater biodiversity on the walls of the device by providing them with a clamping surface where the plants/organisms find attachment points for growing. The plurality of holes provides a similar technical effect, but the holes increase the strength of the connection/attachment between said biodiversity and the device. Holes of a plurality of sizes improves the fixing capability of the device for initiating the proliferation of underwater vegetal biodiversity and/or of sessile underwater biodiversity, since a wider range of attachment/fixing options (i.e., sizes) are available for underwater vegetal biodiversity and/or for sessile underwater biodiversity to start growing attached to the device.

The proliferation of underwater vegetal biodiversity and/or of sessile underwater biodiversity on the walls of the device (especially on the primary wall) provides the one or more internal compartments with the necessary protection for animal biodiversity. Thus, the plants and/or sessile underwater organisms proliferating on the one or more walls of the device provide shadow to the one or more internal compartments, and provides a cover shield that hides any animal biodiversity, such that predators cannot visually detect their presence from outside the device, thereby reducing the risk of being attacked by a predator.

According to preferred embodiments of the invention, at least one of the end portions of one or more of the internal compartments may be configured to be at least partially free of the one or more walls of the shield structure, such that said at least one of the end portions of the one or more of the internal compartments may comprise at least one opening. Thus, at least one of the end portions of one or more of the internal compartments may comprise at least one opening. Said end portions may be configured to be at least partially (i.e., partially or completely) free of the one or more walls of the device and/or shield structure, thereby forming or defining at least one opening. An end portion being completely free of the one or more walls of the device and/or of the shield structure defines an open-end portion, i.e. the end portion comprises only one opening covering the entire area of the end portion, such that the entire area of the respective end portion remains uncovered by any of the walls. An end portion being partially free of (or partially covered by) the one or more walls may be configured to comprise one or more openings, wherein at least a part of the area of the end portion may be free of the one or more walls of the shield structure (i.e. the end portion may be partially covered by one of the walls of the shield structure, e.g. a covering wall), while at least another part of the area of the respective end portion is covered by at least one of the one or more walls of the shield structure (e.g. a covering wall, preferably configured as a lateral wall). The partially free end portions are also referred to as partially open end portions.

In some embodiments, at least one of the internal compartments may be configured to comprise at least one opening on each of its two end portions, thereby defining at least one internal compartment configured as a passage or tunnel. For each compartment, each end portion may be configured as open-end portion or as a partially open end portion. In some embodiments, at least one of the internal compartments having both ends portions configured as respective open-end portions may comprise an inner dividing wall configured to divide the respective internal compartment into two respective sub-compartments, wherein each sub-compartment extends from the respective open-end portion to the inner dividing wall, thereby forming a blind passage/tunnel (i.e., a cave).

An internal compartment having at least one opening in only one of its end portions defines an artificial cave, which is especially advantageous for the proliferation of particular kinds of underwater biodiversity requiring a dark environment and/or protection against any strong flow of water. Since such internal compartments only have one end portion with one or more openings (it is noted that the referred end portion may be configured as an open-end portion or as an partially open portion), then the remaining end portion of a respective internal compartment (which is distally arranged) is completely covered by one of the walls (e.g. a cover wall preferably configured as a lateral wall) of the shield structure, so that underwater vegetal proliferation and/or sessile underwater biodiversity proliferation on this wall provides a closure or cover that prevents the light from entering through said wall into the internal compartments or significantly reduces the light reaching the interior of the referred internal compartment.

On the other hand, an internal compartment comprising at least one opening in both its ends may define a passage or conduct, which is especially advantageous for providing a sheltered/safe space for the proliferation of particular kinds of animal biodiversity, which requires more light or which prefer to be exposed to a flow of water circulating between the at least one opening of its respective two distantly arranged end portions. The reduction of the velocity of the flow of water flowing between both ends may be influenced/regulated by providing bigger or smaller openings in the end portions. Thus, an open-end portion allows a more direct entry of an external flow of water, not contributing to a significant reduction in its velocity and force. However, an end portion being partially free of the one or more walls would reduce the flow of water (velocity and mass) entering through said opening.

In some embodiments, the device may comprise at least one internal compartment having at least one opening only in one end portion (i.e. the other end portion remains covered by a wall of the device, preferably by a wall of the shield structure) and/or at least one internal compartment having both ends portions respectively configured to comprise at least one opening each (e.g. by one or both end portions being configured as respective open-end portions). The combination of these two kind of compartments in a single device provides the technical advantage of increasing the compatibility of the device with a wider number of species of underwater animal biodiversity, so that a plurality of species can live together in a single device, which improves the fertility of the device for the proliferation of underwater vegetal biodiversity and/or of sessile underwater biodiversity, since the wastes generated by animal biodiversity/species act as fertilisers for underwater vegetal biodiversity and for sessile underwater biodiversity. The greater the number of species of animal biodiversity living in a single device, the higher the quality of the fertilising effect of their waste.

In some embodiments of the invention, the primary wall may be configured to extend along the first direction longer than the secondary wall, thereby forming at least one projecting wing extending beyond at least one of the end portions of at least one of the one or more internal compartments. This type of projecting wing is also referred to as lateral projecting wing. Preferably, at least one projecting wing may extend beyond an end portion of an internal compartment comprising at least one opening. A projecting wing must be interpreted in the context of the current invention as a surface (e.g., a flap, or a flange, or a tab) extending from the primary wall of the shield structure and being configured to overhang beyond the at least one of the end portions (e.g., following the first direction) of one or more of the internal compartments of the shield structure. In some embodiments, the device may comprise a first lateral projecting wing extending from the primary wall at least partially along the first direction and being configured to overhang beyond all the end portions of the respective internal compartments arranged on a first lateral side of the device, and the device may further comprise a second lateral projecting wing extending from the primary wall at least partially along the first direction and being configured to overhang beyond all the end portions of the respective internal compartments arranged on a second lateral side of the device. It is noted that the first lateral side and the second lateral side of the device are to be construed as opposing sides (i.e., distally arranged from each other) of the device along the first direction.

A projecting wing may extend at least partially along the first direction (i.e., the projecting wing may extend partially or completely along the first direction). The feature that a projecting wing extends completely along the first direction means that the projecting wing extends only following the first direction. The feature that the projecting wing extends partially along the first direction means that at least a geometrical component of a vector defining the direction of extension of the projecting wing coincides with, or is parallel to, the first direction.

The projecting wings provide several technical effects depending on its particular configuration and arrangement/position in the device. A projecting wing, independently of is configuration always provides an extra surface for serving as a support for underwater vegetal biodiversity and/or for sessile underwater biodiversity to be attached on both of its faces, since both faces are accessible from outside the device.

In some preferred embodiments at least one projecting wing may be selectively arranged to extend beyond (i.e. to overhang) at least one end portion comprising at least one opening, which provides an extra protection for the animal biodiversity in the respective compartment (the entrance remains partially concealed behind the protruding wing), and also reduces the velocity of an external flow of water flowing near the opening, thereby facilitating the entry of animal biodiversity into the respective internal compartment; these technical effects are even more notorious when said projecting wing is bent towards the at least one opening (by being curved or bent describing an angle).

In some embodiments, a projecting wing may be selectively arranged to extend beyond (i.e., to overhang) at least one end portion being completely covered (i.e. closed) by one of the one or more walls of the shield structure. This has the technical effect of protecting the wall covering the respective end portion, so that the velocity of a flow of water flowing near such a wall is significantly reduced, thus providing an area that allows for a better proliferation of underwater vegetal biodiversity and/or sessile underwater organisms, and that also provides an space specifically indicated for the proliferation of particular types of underwater plant/vegetal biodiversity and/or of sessile underwater biodiversity that require a more protected/quieter environment to grow.

The shield structure may be configured as a monolithic structure (i.e., a monoblock or formed as a single body structure). Preferably, all the walls of the shield structure may be made of a material comprising calcium carbonate, such that the monolithic structure is configured as calcium carbonated shield structure.

According to some preferred embodiments of the invention, the one or more walls of the shield structure may be metal walls, preferably of a biocompatible metal. In some embodiments, one or more of the metal walls of the shield structure may be configured as calcic carbonated metal walls. At least a first plurality of the calcic carbonated metal walls may be integrated into a monoblock calcic carbonated structure. In still more preferred embodiments, all the walls of the shield structure may be configured to be part of a single monoblock calcic carbonated shield structure. A monoblock structure may be interpreted as referring to a structure configured as a single body (i.e., wherein the different parts forming the monoblock structure are not removably attached to each other).

A calcium carbonated metal may be configured as a metal that have been exposed to a chemical reaction that allows for the sedimentation of calcium carbonated (CaCO₃) to form around a metal structure (e.g., by means of an electrolysis method). The calcium carbonation improves the capability of metal for serving as a support for the proliferation of underwater vegetal biodiversity and/or of underwater sessile biodiversity. This effect is surprisingly increased when a plurality of overlapping mesh layers are calcium carbonated together to form one of the one or more walls, since as a result of the calcium carbonation the plurality of overlapping layers (i.e. at least two layers) are connected and the roughness of the respective wall is substantially increased, thereby providing more support for the underwater vegetal biodiversity (e.g. posidonia) and/or for underwater sessile biodiversity to find reliable attachment points. In some preferred embodiments, the combination of two or more overlapping mesh layers of metal conveniently carbonated together may be applied to the primary wall of the device, therefore enhancing the ability of the primary wall to allow the proliferation of underwater vegetal biodiversity.

A shield structure being configured as a calcium carbonated monoblock structure has an improved rigidity, which is especially advantageous for increasing the mechanical resistance of the device, therefore being able to withstand higher efforts, and also reduces the risks during the installation process of the device, since it behaves as a rigid body during the installation.

In some embodiments of the invention, at least one of the one or more walls of the shield structure, preferably at least the primary wall, is configured as a meshed wall made of at least one mesh layer (thus providing the respective wall with a plurality of holes), wherein said at least one mesh layer may be made of metal (preferably a biocompatible metal) or may be made of other biocompatible materials, such as glass foam or a material comprising calcium carbonate. The at least one metal mesh layer may be configured as at least one wire mesh layer (e.g. knitted, welded, electroformed, sintered) and/or at least one metal expanded layer. A wire mesh layer is normally configured to provide less rigidity than a metal expanded layer. On the other hand, a metal expanded layer may be configured to have a smaller number and/or size of holes, thereby reducing visibility trough the metal expanded layer, which reduces the chances of a fish (i.e. animal biodiversity) living inside the internal compartments to be detected by a potential predator when the proliferation underwater vegetal biodiversity and/or of underwater sessile biodiversity is not completely developed on the walls of the device (i.e. at early stages of the proliferation of underwater vegetal biodiversity and/or of underwater sessile biodiversity on the walls of the device).

In preferred embodiments of the invention, the at least one wall of the shield structure configured as a meshed wall may be made of at least two overlapping mesh layers, wherein preferably the at least two overlapping mesh layers may comprise at least two overlapping layers of wire mesh layer, or at least two overlapping layers of metal expanded layer (also known as deployed sheet metal, expanded metal sheet) or a combination of at least one layer of wire metal layer and at least one layer of metal expanded layer. The combination of two or more overlapping mesh layers increases the roughness of the respective wall, as the height of the wall is increased, since the respective wall comprises at least two differentiated levels. This has the effect of providing an improved support for the underwater vegetal biodiversity and/or for the underwater sessile biodiversity to find reliable attachment points.

The combination of two or more wire mesh layers to form a single wall of the shield structure (preferably, at least a primary wall) is especially advantageous to provide a wide range of hole sizes. This technical effect is more notorious when each of the two or more mesh layers comprises different mesh sizes and/or when each of the two or more mesh layers are arranged in a misaligned configuration (i.e., when the holes defined by each of the wire mesh layers are not arranged coincidentally).

On the other hand, the combination of at least one expanded mesh layer with at least one wire mesh layer to form a single wall of the device (preferably, to form at least the primary wall) has been found to be particularly advantageous. Due to the different nature of the manufacturing processes followed to obtain a wire mesh layer and to obtain a metal expanded layer, the plurality of holes in each kind of mesh layer will be differently arranged, which facilitates the construction of the device when this particular arrangement is desired due to its previously described advantage of providing an improved support for the underwater vegetal biodiversity and/or for the underwater sessile biodiversity.

According to some preferred embodiments, at least one of the one or more walls of the shield structure, preferably the primary wall, may comprise (i.e., may be configured to have) at least one curved surface and/or one or more flat surfaces.

Preferably, said at least one curved surface and/or said one or more flat surfaces may comprise at least one inward protrusion configured to protrude inwards with respect to the one or more internal compartments, and/or at least one outward protrusion configured to protrude outwards with respect to the one or more internal compartments. The protrusions may be distributed irregularly on the respective surface and/or may be configured to have a plurality of shapes and dimensions. Thus, a plurality of protrusions may be configured such that the protrusions have different shapes (i.e., the protrusions may comprise a plurality of different/irregular shapes). The protrusions provide the technical effect of defining an irregular surface, which is especially advantageous for the underwater vegetal biodiversity and/or for the underwater sessile biodiversity to find reliable attachments on the respective wall. The at least one curved surface may comprise a plurality of undulations. The undulations (with or without protrusions) may be configured to define independent internal compartments (each undulation may define a respective internal compartment), or a plurality of undulations may be integrated in a part of a wall defining only one single compartment.

According to some embodiments, the device may further comprise at least one auxiliary connecting element configured to connect a lower part of the primary wall to the secondary wall (e.g., when the lower part of the primary wall is spaced apart from the secondary wall along a front direction), wherein the one or more internal compartments may comprise a lower internal compartment delimited by the primary wall, the secondary wall and the at least one auxiliary connecting element, and at least one upper internal compartment, arranged above the lower compartment, and delimited by the primary wall and the secondary wall. Preferably, at least a part of the primary wall delimiting the at least one upper compartment is configured as a convex surface pointing towards a front part of the device; and/or at least a part of the primary wall delimiting the lower compartment is configured as a concave surface pointing towards a rear part of the device.

In preferred embodiments of the invention, the device may further comprise a container structure comprising one or more walls defining one or more storage compartments. The container structure may be configured to extend from a top part to a bottom part along a vertical direction. In some embodiments, at least one of the one or more walls of the container structure, preferably at least may comprise a plurality of holes. The container structure may be configured as a receptacle box, preferably as a receptacle having an upper end portion configured as an open end portion (partially or totally open).

Preferably, the secondary wall of the shield structure is arranged between the one or more internal compartments of the shield structure and the one or more storage compartments of the container structure. In more preferred embodiments, the secondary wall of the shield structure is configured to separate the one or more internal compartments of the shield structure from the one or more storage compartments of the container structure, i.e. the secondary wall may be configured as a separator element between said internal compartments and said storage compartments. Hence, in some embodiments, the secondary wall may be an integral part of the shield structure and of the container structure simultaneously.

In some embodiments, the walls of the container structure may have any of the features previously described for the walls of the shield structure. Thus, for example, the materials described for the one or more walls of the shield structure are also applicable to the one or more walls of the container structure. Thus, the one or more walls of the container structure may be metal walls or walls made of a biocompatible material (preferably a biocompatible material comprising calcium carbonate, such as a ceramic comprising calcium carbonate or a metal comprising calcium carbonate). In some embodiments the shield structure and/or the container structure may be configured as respective monoblock structures, while in preferred embodiments, the whole device may be configured as a single monoblock structure (e.g., calcic carbonated).

In preferred embodiments, the shield structure and the container structure are made of the same material.

In some alternative embodiments of the container structure (being compatible with any of the configurations for the shield structure, with the exception of those in which the shield structure is specifically made of a biocompatible material), at least a part of the container structure may be made of a non-biocompatible material configured to avoid the proliferation of living organisms in contact with said at least part of the container structure.

In some embodiments, one or more of the walls of the container structure may be made of a material comprising calcium carbonated. At least a first plurality of walls of the container structure may be integrated into a monoblock calcic carbonated structure. In the context of the present invention monobloc is to be interpreted as monolithic, i.e., as being formed as a single body. In still more preferred embodiments, all the walls of the container structure may be configured to be part of a single monoblock structure, preferably a monoblock calcic carbonated shield structure.

In preferred embodiments, the container structure and the shield structure may be configured to form a single monoblock structure, more preferably to form a single calcic/calcium carbonated monoblock structure.

According to some embodiments, the primary wall of the shield structure may comprise an upper wing projecting upwardly at least partially along the vertical direction beyond the top part of the container structure, and/or the bottom part of the container structure may extend longer downwards along the vertical direction than the primary wall of the shield structure, thereby leaving a lower portion of the container structure unprotected by the primary wall of the shield structure. This has the advantage of providing a space for allowing that an external flow of water enters through the front part of the device into the container structure to interact, for example, with passive sound-producing elements.

Optionally, the upper wing may also extend partially backwards from the primary wall towards the container structure, which has the technical advantage of providing a partial covering for the one or more opening arranged at the top part of the container structure, while at the same time provides a surface configured to generate a downward force as a result of its interaction with the surrounding water.

In some embodiments, the shield structure (independently of whether there is a container structure or not) may be configured such that at least one area of the secondary wall may be free of the primary wall along the vertical direction, such that said area does not form/surround any internal compartment (i.e., said at least one area of the secondary wall is not integrated into any internal compartment). This may be achieved by configuring the primary wall to not frontally oppose the whole surface of the secondary wall. Thus, the primary wall may be configured to be shorter along the vertical direction than the secondary wall (e.g., leaving exposed an upper and/or the lower portion of the secondary wall), or the primary wall may be configured to have one or more gaps along the vertical direction (e.g., the primary wall may comprise two or more primary sub-walls separated by a gap). Preferably, when the device comprises a container structure, the bottom part of the container structure may extend longer downwards along the vertical direction than the primary wall of the shield structure, thereby forming the at least one area of the secondary wall being free from the primary wall in a lower part of the secondary wall. This at least one area has the advantage of exposing the content of the container structure to the water force.

In some embodiments, at least one of the one or more walls of the container structure may be configured as a meshed wall made of at least one mesh layer or at least two mesh layers, wherein any combination of layers previously described for the shield structure may also be applied to the walls of the container structure.

In preferred embodiments of the invention, at least one of the one or more storage compartments may comprise: at least one storage element configured to capture and store contaminating substances; and/or at least one device configured to measure underwater environmental conditions; and/or a plurality of passive sound-producing elements configured such that, when a flow of water enters the respective storage compartment through the plurality of holes of the one or more walls of the container structure, the flow of water moves the plurality of passive sound-producing elements causing contacts between them, thereby producing a sound. Preferably, the plurality of passive sound-producing elements may comprise shells (e.g., oyster shells) or may be configured as shells.

A storage element configured to capture and store contaminating elements provides a mechanism for reducing the presence of any contaminating substance (e.g., contaminants, contaminated agents or particles) in the device, thereby reducing the risks to the life of any biodiversity living in the device, thus favouring the proliferation of biodiversity even when contaminated agents are present in the environment.

The presence of devices configured to measure underwater (i.e., subaquatic) environmental conditions provides the device with the possibility of acquiring data related to the proliferation of biodiversity in the device and/or related to the detection of contaminating substances/agents/particles in the device. This information may be useful, for example, for detecting when the device is or is not achieving its target of promoting biodiversity. In some cases, this information may be used for determining a change of location of the device, for example when it is detected that the area where the device is located has been contaminated in such a way that biodiversity cannot expected to grow for a certain period of time.

The presence of passive sound-producing elements provides the technical effect of attracting biodiversity, in particular, animal biodiversity to the device.

In preferred embodiments of the invention, the container structure may comprise one or more apertures (i.e., openings), preferably being arranged at a top portion of the container structure. The top portion (or upper portion) of the container structure is the part of the container structure which is configured to be on top of the device (considering a vertical direction) when the device is in its working position (when the primary wall of the shield structure is arranged as a front wall of the device). In preferred embodiments, the one or more apertures may be configured to access at least one of the one or more storage compartments. Preferably, said one or more apertures/openings are configured to allow the introduction of external elements (e.g., the at least one storage element configured to capture and store contaminating substances and/or the at least one device configured to measure underwater environmental conditions and/or the plurality of passive sound-producing elements) into the at least one of the one or more storage compartments.

In some embodiments, the container structure may further comprise fixation/attachment means configured to fix/attach/connect the device to an auxiliary subaquatic structure external to the device. The attachment means may be configured, for example, as chains and/or clamps. The aim of such attachment means is providing the necessary clamping or attaching force, so as to hold the device in its position without allowing a substantial movement or displacement of the device. In preferred embodiments the attaching means are configured to be attached to the auxiliary external structure, such that the device is hanging from the auxiliary external structure without being standing or resting on a ground or floor.

A second aspect of the invention refers to a system comprising at least one device for the proliferation of underwater biodiversity according to any of the embodiments previously described and an auxiliary subaquatic structure external to the at least one device, wherein the at least one device is attached or connected to the auxiliary subaquatic structure by means of attaching means. An auxiliary subaquatic structure refers to any structure providing support for the devices, such as columns, walls, or subaquatic infrastructures (e.g., structures present in a seaport). The attaching means may be integrated as a part of the device (e.g., by the secondary wall or the container structure comprising the attaching means) or may be external to the device (e.g., by the auxiliary subaquatic structure comprising the attaching means or by the attaching means being external to both the auxiliary subaquatic structure and the device).

### BRIEF DESCRIPTION OF THE FIGURES

FIG. 1 illustrates a first embodiment of a device for the proliferation of underwater biodiversity comprising a shield structure according to embodiments of the invention. In particular, FIGS. 1a-1c show respectively an isometric view, a side view and a front view of a device according to the invention.

FIG. 2 illustrates several configurations compatible with embodiments of the invention. In particular, FIGS. 2a-2d depicts side views of four different embodiments of a device for the proliferation of underwater biodiversity according to embodiments of the invention.

FIG. 3 illustrates a second complete embodiment of a device for the proliferation of underwater biodiversity comprising a shield structure according to embodiments of the invention. In particular, FIGS. 3a-3c show respectively an isometric view, a side view and a front view of a device according to the invention.

FIG. 4 illustrates a third embodiment of a device for the proliferation of underwater biodiversity comprising a shield structure according to embodiments of the invention. In particular, FIGS. 4a-4c show respectively an isometric view, a side view and a front view of a device according to the invention.

FIG. 5 illustrates an embodiment of the invention comprising a container structure. In particular, FIG. 5a shows a container structure according to the invention, while FIGS. 5b-5d depict different views of a device for the proliferation of underwater biodiversity comprising a shield structure and a container structure according to embodiments of the invention.

FIG. 6 illustrates several configurations compatible with embodiments of the invention. In particular, FIGS. 6a-6d depicts side views of four different embodiments of a device for the proliferation of underwater biodiversity comprising a shield structure and a container structure according to embodiments of the invention.

FIG. 7 illustrates different views of an embodiment according to the invention.

FIG. 8 illustrates a system comprising a plurality of devices for the proliferation of underwater biodiversity attached to an auxiliary subaquatic structure.

### DESCRIPTION OF PREFERRED EMBODIMENTS OF THE INVENTION

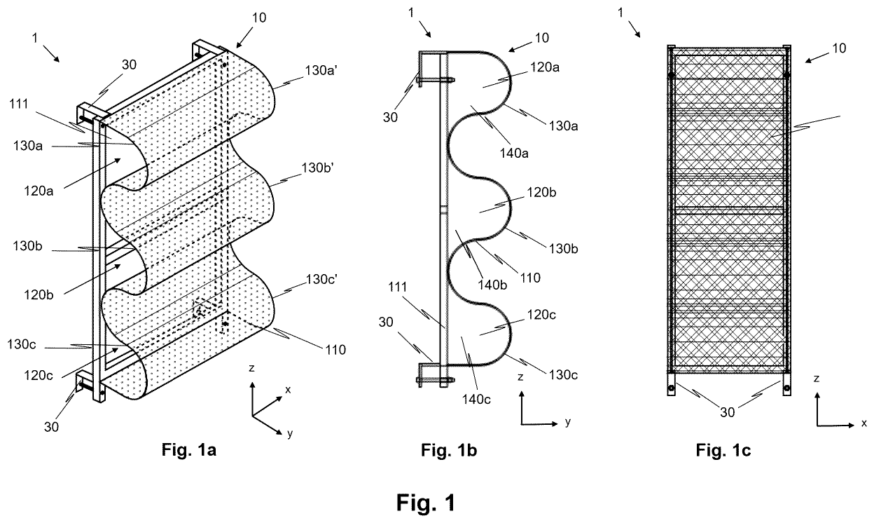

FIG. 1 shows a first embodiment of the invention. The device 1 for the proliferation of underwater biodiversity shown in FIGS. 1a-1c comprises a shield structure 10, which further comprises a first wall 110 and a second wall 111 defining a plurality of internal compartments 120a, 120b and 120c. The first wall is configured as a primary wall, being arranged as a front wall of the device, while the second wall is configured as a rear wall of the device. The primary wall 110 of the device 1 shown in FIGS. 1a-1c is depicted as an undulated wall defining three different internal compartments 120a-120c between the primary wall 110 and the secondary wall 111. It is noted that the embodiment shown in FIGS. 1a-1c is shown as specifically comprising three compartments, but the embodiments is compatible with any number of internal compartments (e.g., one or a plurality such as two, three, four, five or more compartments) and with other shapes for the primary wall 110.

Each of the internal compartments 120a-120c comprises two respective end portions: 130a and 130a′ for the internal compartment 120a; 130b and 130b′ for the internal compartment 120b; and 130c and 130c′ for the internal compartment 120c. In this particular embodiment, all the end portions are configured as open-end portions, i.e. all the end portions comprises respective openings 140a, 140b and 140c. In particular, the end portions depicted in FIGS. 1a and 1b are configured as open-end portions, i.e. as end portions being completely free of any of the walls of the device. Hence, the open-end portions remain completely uncovered (i.e., not covered by any of the walls of the device). In compatible embodiments, some of the openings may be configured to be at least partially covered by one or more of the walls of the device. The internal compartments 120a-120c are therefore configured as respective passages or tunnels.

Each of the internal compartments 120a-120c extends completely along a first direction “x”, which in this case is a substantially horizontal direction, but in other cases may be arranged differently (vertical direction or inclined direction). However, in some compatible embodiments, the one or more internal compartments may be configured to extend partially along a first direction, e.g. by the internal compartment being inclined with respect to the first direction (e.g. 45 degrees), such that the internal compartment extends partially along a first direction (e.g. the internal compartments may extend partially along a vertical direction and partially along a horizontal direction when the first direction is a horizontal direction). A curved internal compartment would also extend partially along the first direction.

Despite the particular configuration shown in FIGS. 1a-1c, in some compatible embodiments, the shield structure may comprise at least one internal compartment having at least one opening only in one end portion (i.e. the other end portion remains covered by a wall of the device, preferably by a wall of the shield structure) and/or at least one internal compartment having both ends portions respectively configured to comprise at least one opening each (e.g. by one or both end portions being configured as respective open-end portions, e.g. by one or both end portions being configured as respective open-end portions or by being partially free of the walls of the shield structure). Further, at least one of the internal compartments having both ends portions configured as respective open-end portions may comprise an inner dividing wall configured to divide the respective compartment into two respective sub-compartments, wherein each sub-compartments extends from the respective open-end portion to the inner dividing wall, thereby forming a blind passage (i.e., a cave).

The primary wall 110 is configured as a metal wall or a biocompatible material (according to the description provided in the summary) having a plurality of holes. Although is not perceptible in FIGS. 1a-1c, the primary wall may be configured as a meshed wall made of at least one mesh layer (thus providing the respective wall with a plurality of holes). The at least one mesh layer may be configured as at least one wire mesh layer (e.g., knitted, welded, electroformed, sintered) and/or at least one metal expanded layer. A wire mesh layer is normally configured to provide less rigidity than a metal expanded layer. A metal expanded layer may be configured to have a smaller number and/or size of holes than a wire mesh layer. These configurations are also applicable to the secondary wall 111.

The primary wall 110 of the shield structure may also be configured as a meshed wall made of at least two overlapping mesh layers, wherein preferably the at least two overlapping mesh layers may comprise at least two overlapping layers of wire mesh layer, or at least two overlapping layers of metal expanded layer (also known as deployed sheet metal, expanded metal sheet) or a combination of at least one layer of wire metal layer and at least one layer of metal expanded layer.

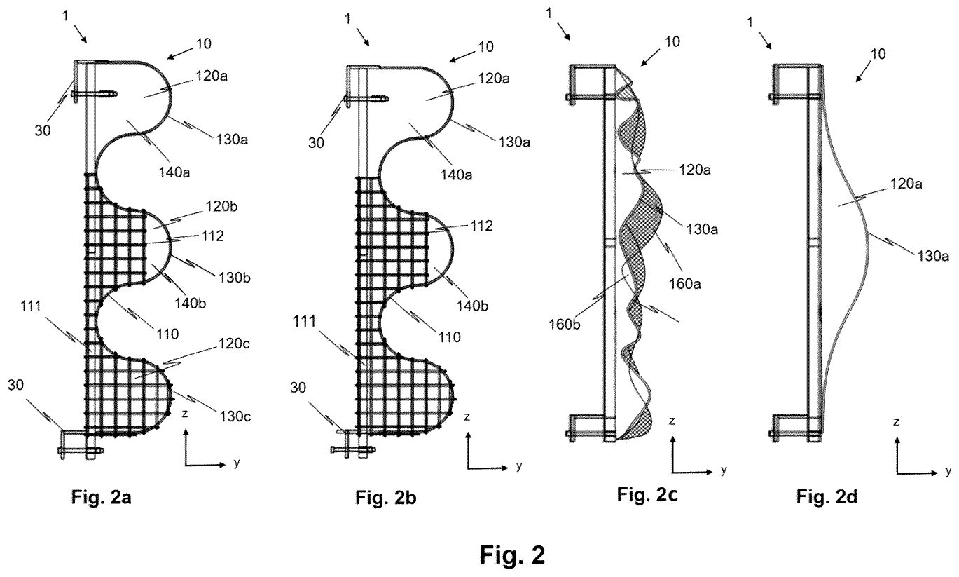

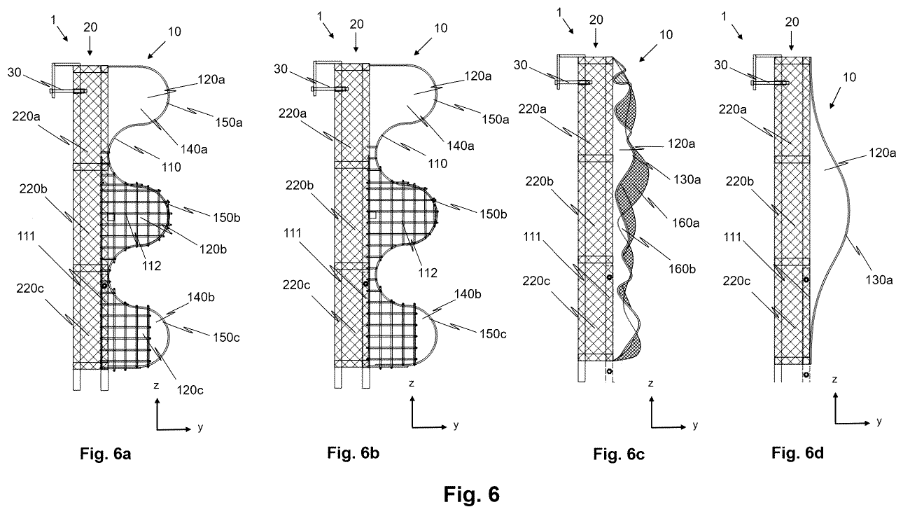

The primary wall 110 shown in FIGS. 1a-1c is represented as a curved wall comprising a plurality of undulations. However, other configurations for the primary wall are compatible with the embodiment of FIGS. 1a-1c (such as the configurations shown in FIGS. 2a-2d or in FIG. 6a).

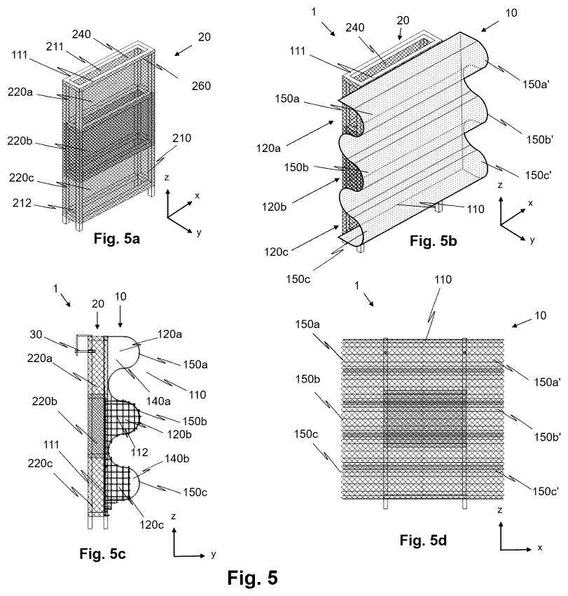

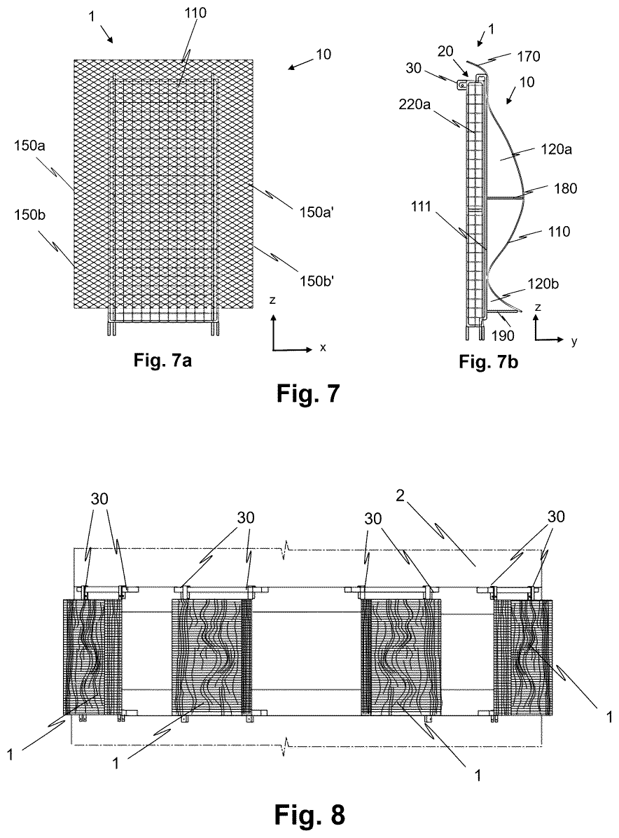

The secondary wall 111 of FIGS. 1a-1c is configured as rear wall or rear cover wall. Although is not perceivable in the figures, the secondary wall 111 may be made of metal or a biocompatible material (according to the description provided in the summary), may comprise a plurality of holes, and may additionally be configured as a mesh wall made of at least one mesh layer. The features described for the primary wall 110 are also compatible with, and may be applied to, the secondary wall 111. The device 1 of FIGS. 1a-1c further comprises attachment means 30 configured for connecting/attaching the device to a structure external to the device, in particular, to an auxiliary subaquatic structure external to the device. The attachment means is an optional feature of the device, since these means may be integrated into the device 1 (e.g. by the secondary wall 110 or the container structure 20 comprising the attaching means—this second configuration shown in FIG. 5c and FIGS. 7a-7d) or may be external to the device (e.g. by the auxiliary subaquatic structure comprising the attaching means 30 or by the attaching means 30 being external to both the auxiliary subaquatic structure 2 and the device 1).

Although is not perceivable in the figures, the primary wall 110 may be configured as a first sub-structure, while the secondary wall 111 may be configured as a second sub-structure, wherein both sub-structures are connected together to form the shield structure 10 of the device 1. Alternatively, the primary wall 110, the secondary wall 110 and any further wall of the shield structure 10 may be configured to form a single monoblock shield structure 10 (i.e., single body structure, also referred to as monolithic structure). Preferably, all the walls 110, 111 of the shield structure 10 may be made of a material comprising calcium carbonate, such that the monolithic shield structure is configured as calcium carbonated shield structure 10.

FIGS. 2a-2d show several side views disclosing configurations for the primary wall 110 of the device shown in FIGS. 1a-1c. The number of compartments is not limiting, since the device may comprise only one internal compartment or a plurality of internal compartments (e.g., two, three, four, five or more compartments). In particular, FIG. 2a shows the same configuration already described in FIG. 1b, but in this case, only the upper internal compartment 120a comprises an open-end portion 130a. The second compartment 120b (i.e., the intermediate compartment) comprises an end portion 130b configured as being partially covered by a covering wall 112 (wherein the covering wall 112 is configured as a lateral wall of the device) of the shield structure 10 (i.e., the end portion 130b is partially free of the wall of the shield structure 10), thereby defining an opening 140b having an area smaller than the area of the cross-section of the end portion 130b. A covering wall is compatible with the constructive features (e.g., materials and mesh layer configurations) of the primary 110 and the secondary 111 walls. Finally, the lower internal compartment 120c is depicted as having one end portion 130c being completely covered by the covering wall 112 of the shield structure. It is noted that the each of the end portions of the internal compartments 120a-120c not visible in FIG. 2a (i.e., the end portions 130a′-130c′) may be configured as any of the end portions 130a-130c.

FIG. 2b shows a similar configuration to that shown in FIG. 2a, but in this case the walls of the shield structure define a single internal compartment 120a, since the primary wall 110 is only connected to the secondary wall 111 by the upper and the lower portions of the shield structure 10. Therefore, the internal compartment 120a only comprises a visible end portion 130a comprising two respective openings 140a and 140b. It is noted that an end portion being partially covered by a wall of the shield structure (i.e., partially free of the one or more walls of the shield structure) may comprise a plurality of openings.

FIG. 2c shows an embodiment in which the primary wall 110 is configured as a curved surface comprising a plurality of inward 160b and outward 160a protrusions, thereby forming an irregular surface. This configuration may allow the definition/formation of a single internal compartment or of a plurality of compartments, depending on the height of the protrusions. FIG. 2d shows an embodiment in which the primary wall 110 is configured as a curved surface defining a single internal compartment 120a.

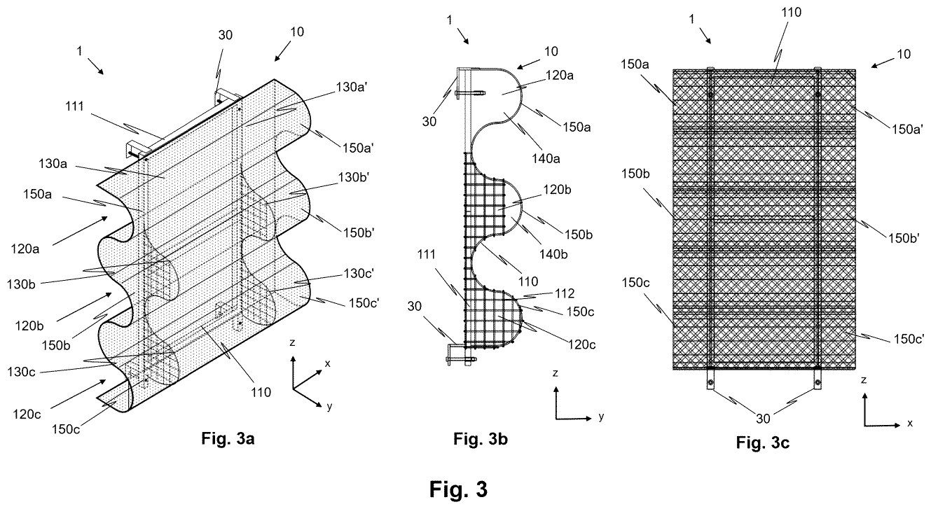

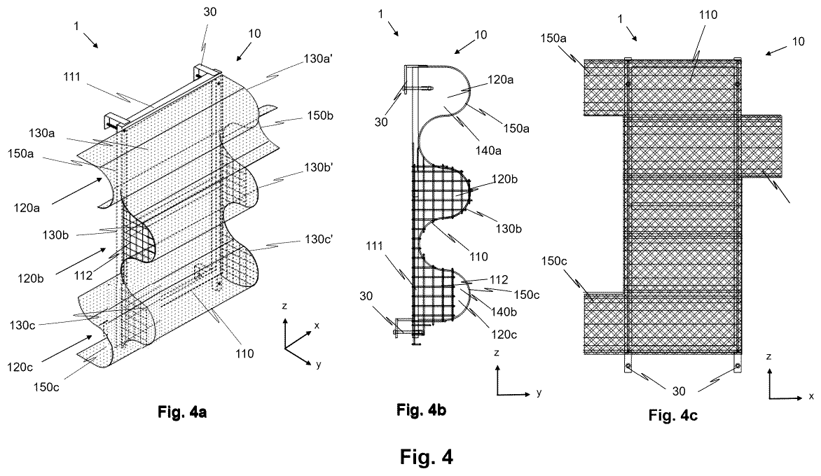

FIG. 2d shows embodiment of the invention in which the primary wall 110 is curved to form a single undulation configured as convex shape extending towards a front part of the device (i.e., along the positive “y” direction) FIGS. 3a-3c illustrate an embodiment based on the configurations already described in FIGS. 1 and 2, but further disclosing the technical feature of the projecting wing or wings. The primary wall 110 is configured to extend along the first direction “x” longer than the secondary wall 111, thereby forming respective projecting wings 150a-150c and 150a′-150c′ extending beyond the end portions 130a-130c and 130a′-130c′ of the internal compartments. In this case reference signs 150a-150c identify a first projecting wing, while reference sings 150a′-150c′ identify a second projecting wing. The first projecting wing is configured to overhang beyond all the end portions 130a-130c arranged on a first lateral side of the device 1, while the second projecting wing is configured to overhang beyond all the end portions 130a′-130c′ arranged on a second lateral side of the device 1, wherein the first and second lateral sides of the device are distal sides of the device 1 along the first direction “x”. Thus, the projecting wings shown in FIGS. 3a-3b are configured as lateral extensions of the primary wall 110 along the first direction “x”. However, other configurations are possible (such as selectively arranged projecting wings), according to the description provided in the summary of the invention, and also according to the disclosure of FIGS. 4a-4c.

Despite the particular configuration shown in FIGS. 3a-3c, in some compatible embodiments, the shield structure 10 may comprise at least one (e.g. two or three) internal compartment having at least one opening only in one end portion (i.e. the other end portion remains covered by a wall of the device, preferably by a wall of the shield structure) and/or at least one (e.g. two or three) internal compartment having both ends portions respectively configured to comprise at least one opening each (e.g. by one or both end portions being configured as respective open-end portions, or by being partially free of the walls of the shield structure). Further, in some compatible embodiments, at least one of the internal compartments having both ends portions configured as respective open-end portions may comprise an inner dividing wall configured to divide the respective internal compartment into two respective sub-compartments, wherein each sub-compartment extends from the respective open-end portion to the inner dividing wall, thereby forming a blind passage/tunnel (i.e., a cave).

FIGS. 4a-4c depict an embodiment representing a variation of the embodiment shown in 3a-3c, in which the projecting wings are selectively arranged, instead of being arranged extending along both lateral edges of the primary wall 110. Particularly, FIGS. 4a-4c show that three wings are arranged at three respective end portions that comprises an opening.

The projecting wings are optional features of the device. Hence, the particular configurations for the compartments shown in FIGS. 4a-4c must be considered also independently of the presence of any projecting wing. The number of internal compartments shown in the figures is three only for illustrative purposes. However, the shield 10 structure of FIG. 4a-4c may comprise at least one internal compartment having at least one opening only in one end portion (i.e. the other end portion remains covered by a wall of the device, preferably by a wall of the shield structure) and/or at least one internal compartment having both ends portions respectively configured to comprise at least one opening each (e.g. by one or both end portions being configured as respective open-end portions, or by being partially free of the walls of the shield structure). Optionally, an inner dividing wall may be arranged at least one of the internal compartments having both ends portions configured as respective open-end portions may comprise an inner dividing wall configured to divide the respective internal compartment into two respective sub-compartments

In particular, FIGS. 4a-4c show the internal compartment 120a configured as a passage or tunnel (i.e., the internal compartment comprises at least one opening on each of its two end portions—more particularly, in the figures the internal compartment comprises two respective open-end portions). Additionally, FIGS. 4a-4c also illustrate two respective compartments 120b and 120c configured as caves (i.e., the internal compartments 120b and 120c have at least one opening in only one of its end portions—130b′ and 130c). It is noted that the caves are oppositely oriented, so as to have their respective openings distally arranged.

FIG. 5a shows a container structure 20 for a device according to the invention. The container structure 20 comprises a plurality of walls 210, 211 defining at least one storage compartment. In particular, the configuration shown in FIG. 5a depicts a container structure comprising three storage compartments 220a-220c, although it may comprise a single storage compartment. The container structure 20 is shown as comprising an aperture 240 arranged at the top portion 260 of the container structure 20. However, the container structure 20 may optionally comprise more openings, for example, one or more openings may be arranged in covering walls 212 (e.g., a covering wall configured as a lateral/side wall) of the container structure 20. The container structure 20 of FIG. 5a comprises an optional box structure defining an additional storage compartment 220b.

The container structure 20 may be configured as a monoblock structure. Preferably, all the walls of the container structure 20 may be made of a material comprising calcium carbonate, such that the monolithic structure is configured as calcium carbonated container structure.

The one or more walls of the container structure 20 are compatible with the features previously described for the walls of the shield structure of the preceding figures. Thus, for example, the one or more walls of the container structure may be metal walls or may be made of a biocompatible material. Additionally, one or more of the walls of the container structure 20 may be made of a material comprising calcium carbonate. At least a first plurality of the walls made of material comprising calcium carbonate may be integrated into a monoblock calcic carbonated structure. In still more preferred embodiments all the walls of the container structure 20 may be configured to be part of a single monoblock calcic carbonated shield structure.

FIGS. 5b-5c show an embodiment of a device 1 according to the invention comprising a container structure 20 and a shield structure 10. Although the shield structure depicted in FIG. 5b-5c substantially corresponds to that of the embodiment shown in FIGS. 3a-3c, it is noted that any of the shield structures 10 previously described may be combined with a container structure 20. Hence, the projecting wings (i.e., lateral wings) and the covering walls partially or totally covering the end portions of the internal compartments may be regarded as optional features.

FIGS. 6a-6d represent the same embodiments previously described in FIGS. 2a-2d, but in this case in combination with a container structure, such that the secondary wall 111 of the shield structure 10 is arranged between the one or more internal compartments 120a-120c of the shield structure 10 and the one or more storage compartments 220a-220c of the container structure 20. In particular, the secondary wall 111 of the shield structure 10 is shown as being configured to separate the one or more internal compartments 120a-120c of the shield structure 10 from the one or more storage compartments 220a-220c of the container structure 20, i.e. the secondary wall 111 is configured as a separator element between said internal compartments and said storage compartments. In FIG. 6a-6d, the secondary wall 111 of the shield structure 10 is depicted as being simultaneously an integral part of the shield structure 10 and of the container structure 20.

Although is not perceivable in the figures, the container structure 20 and the shield structure 10 may be configured to form a single monoblock structure, more preferably to form a single calcic/calcium carbonated monoblock structure.

The device shown in FIGS. 6a-6d comprises attachment means 30 in a rear part of the container structure. However, is an optional feature, since, as previously described, the attaching means may be integrated as a part of the device (e.g. by the secondary wall or the container structure comprising the attaching means) or may be external to the device

In preferred embodiments, the container structure 20 and the shield structure 10 of the device 1 may be configured to form a single monoblock structure, more preferably to form a single calcic/calcium carbonated monoblock structure.

FIGS. 7a and 7b illustrate another embodiment of a device 1 according to the invention. The device 1 of FIG. 7 comprises a shield structure 10 and a container structure 20. The primary wall 110 of the shield structure 10 comprises an upper wing 170 projecting upwardly at least partially along the vertical direction (direction “z”) beyond the top part of the container structure 20. Additionally, the bottom part of the container structure 20 is configured to be longer downwards along the vertical direction “z” than the primary wall 110 of the shield structure 10, thereby leaving a lower portion of the container structure unprotected by the primary wall 110 of the shield structure 10. It is noted that the upper wing 170 and the longer bottom part of the container structure 20 are optional features, whose integration into a device may be considered independently.

The device of FIG. 7. comprises two respective lateral projecting wings 150a-150b and 150a′-150b′, one at each lateral side of the device. However, this embodiment is also compatible with selectively arranged projecting wings or with having no projecting wings.

The device of FIG. 7 comprises at least one auxiliary connecting element 190 configured to connect a lower part of the primary wall 110 to the secondary wall 111. The device comprises a lower internal compartment 120b delimited by the primary wall 110, the secondary wall 111 and the at least one auxiliary connecting element 190. Although it not visible in the figure, each of the at least one auxiliary connecting element 190 may be configured as one or more auxiliary connecting bars/rod or as one or more auxiliary connecting walls 190. In preferred embodiments, the auxiliary connecting element 190 is arranged horizontally, as shown in FIG. 7b. The device further comprises an upper internal compartment 120a (although in other embodiments more upper compartments may be included), arranged above the lower compartment 120b, and delimited/defined (i.e., formed) by the primary wall 110 and the secondary wall 111. Optionally, the auxiliary connecting element 190 may be configured as a wall configured to close at least partially the lower internal compartment at its lower side, while, in other embodiments, the auxiliary connecting element 190 may be configured as one or more bars/rod leaving openings at the lower side/part of the lower internal compartment 120b.

Further, the primary wall 110 of the shield structure has a specific geometrical configuration that has been found to provide specific advantages. The primary wall 110 is configured as a surface that comprises an upper part forming the upper internal compartment 120a, and a lower part forming the lower internal compartment 120b. It is noted that a lowest part of the primary wall 110 is separated from the secondary wall 111, such that the auxiliary connecting element 190 is required to provide structural stability to the lower internal compartment 120b. Thus, the shield structure 10 comprises at least one auxiliary connecting elements 190 configured connect the primary wall 110 to the secondary wall 111, wherein optionally the at least one auxiliary connecting element 190 is configured as a wall configured to at least partially close the lower part of the lower internal compartment 120b.

The upper part is preferably connected to the secondary wall 111 at a first contact position substantially coincidentally arranged with the top part of the container structure 20 (e.g., in the range of 75-100% of a height of the device, more preferably in the range 80-90%), and at a second contact position arranged at a location of the secondary wall 111 substantially coincidentally arranged with a vertical position of the container structure in the range 10-50% of its vertical height (preferably 25-40%, and more preferably 15-20%) A further optional reinforcing connection is provided by a structural reinforcement 180 (e.g., a bar/rod) configured to connect a point of the upper part of the surface being distally arranged with respect to the secondary wall 111 distant point of the upper part. This indirect connection is especially useful when the upper compartment is bigger than the lower compartment.

In particular, the lower part of the primary wall 110 forming the lower compartment 120b extends from the second contact position to the auxiliary connecting element 190. An area of the secondary wall 111 is free from a frontal opposition (in the “y” direction) of the primary wall 110, such that said area of the secondary wall does not delimit any internal compartment. It is noted that in FIG. 7 the bottom part of the container structure 20 is configured to be shorter than the primary wall 110 along the vertical direction “z”, thereby forming said area of the secondary wall being free of the primary wall. The auxiliary connecting element 190 is preferably connected to the secondary wall 111 in a position of approximately a 5-15% of the height of the container structure. However, in other embodiments the primary wall 110 and the secondary wall may extend equally downwards along the vertical direction “z”. In an alternative embodiment, the primary wall may comprise two or more primary sub-walls, such that a gap is created between the two or more primary sub-walls, thereby generating an area of the secondary wall 111 free of the frontal opposition of the primary wall 110.

The upper part of the surface of the primary wall 110 is shown in FIG. 7b configured as a convex shape/surface (viewed from outside the device, in particular from the front of the device) pointing forwards (e.g., a belly-shaped curve pointing to the front of the device along the direction “y”). The interaction of the upper part and the lower part of the surface of the primary wall 110 forms a concavity (viewed from the front part of the device). This concavity has the advantage of interacting with the water surrounding the device such that a retaining force is generated for holding the device in its working position (this force generates a torque with respect to the attaching means (30), which are preferably arranged at the top of the container structure 20.

Further, FIG. 7b shows that the upper wing 170 extends partially backwards from the primary wall 110 towards the container structure, which is an optional feature of the embodiment. re.

FIG. 8 illustrates a system according to a second aspect of the invention. For illustrative purposes, the devices 1 depicted in FIG. 8 have been represented as substantially corresponding to the devices shown in FIGS. 2c and/or 6c. However, it is noted that the system may comprise any device according to the description previously provided. Even devices having different configurations may be integrated into a single system. FIG. 8 represents an auxiliary subaquatic structure external to the device (e.g., subaquatic wall, column or infrastructure in a port), and a plurality of four devices 1 according to the invention, conveniently attached to the auxiliary subaquatic structure 2 by means of respective attaching means 30. The system may comprise any plurality of devices.

1. A device for proliferation of underwater biodiversity, the device comprising:
a shield structure comprising
a primary wall configured as a front outer wall comprising at least one curved surface and a secondary wall comprising at least a flat surface, definining one or more internal compartments, wherein each of the one or more internal compartments is arranged between the primary wall and the secondary wall, and wherein said one or more internal compartments comprises two respective end portions configured to be partially free of said primary and secondary walls;
a container structure comprising one or more walls forming one or more storage compartments,
wherein the secondary wall of the shield structure is configured to separate the one or more internal compartments of the shield structure from the one or more storage compartments of the container structure, and
wherein the primary wall and the secondary wall, and the one or more storage compartments comprise a plurality of holes and are configured as a metal wall or as a wall made of a biocompatible material,
wherein said biocompatible material is configured as a material comprising calcium carbonate.

2. The device of claim 1, wherein the biocompatible
material comprises calcium carbonate is configured as a ceramic material, more preferably refractory clay, or is configured as a metal, more preferably a steel with a carbon content in the range 0.05 to 0.5%.

3. The device of claim 1, wherein the primary wall is configured to extend along the first direction longer than the secondary wall, thereby forming at least one projecting wing extending beyond at least one of the end portions of at least one of the one or more internal compartments.

4. The device of claim 3, wherein the at least one projecting wings comprises:
a first projecting wing extending from the primary wall along the first direction, the first projecting wing being configured to overhang beyond all the end portions arranged on a first lateral side of the device; and/or
a second projecting wing extending from the primary wall along the first direction, the second projecting wing being configured to overhang beyond all the end portions arranged on a second lateral side of the device, wherein the first and second lateral sides of the device are distal sides of the device along the first direction.

5. The device of claim 1, wherein the one or more internal compartments comprises:
at least one internal compartment comprising a respective opening at each of its two respective end portions; and/or
at least one internal compartment comprising a respective opening at one of its end portions,
wherein the shield structure further comprises a respective cover wall configured to completely cover the other end portion.

6. The device of claim 5, wherein one or more of the at least one internal compartment comprising a respective opening at each of its two respective end portions further comprises an inner dividing wall configured to divide the respective internal compartment into two respective internal sub-compartments, wherein each sub-compartment is configured to extend from the respective end portion to the inner dividing wall, thereby forming a blind tunnel.

7. (canceled)

8. The device of claim 1, wherein at least one of the one or more walls of the shield structure, is configured as a meshed wall made of at least one mesh layer.

9. The device of claim 8, wherein the at least one of the one or more walls of the shield structure configured as a meshed wall is made of at least two overlapping mesh layers.

10. (canceled)

11. The device of claim 1, further comprising at least one auxiliary connecting element configured to connect a lower part of the primary wall to the secondary wall, wherein the one or more internal compartments comprises:
a lower internal compartment delimited by the primary wall, the secondary wall and the at least one auxiliary connecting element; and
at least one upper internal compartment, arranged above the lower compartment, and delimited by the primary wall and the secondary wall.

12. (canceled)

13. The device of claim 11, wherein:
the primary wall of the shield structure comprises an upper wing projecting upwardly at least partially along the vertical direction beyond the top part of the container structure; and/or
at least one area of the secondary wall is free of the primary wall along at least a part of the vertical direction such that said at least one area does not delimit any internal compartment, wherein preferably the bottom part of the
container structure is configured to extend longer downwards along the vertical direction than the primary wall of the shield structure, thereby forming the at least one area of the secondary wall free of the primary wall in a lower part of the secondary wall.

14. (canceled)

15. The device of claim 1, wherein the shield structure and the container structure are configured to form a single monolithic structure.

16. (canceled)

17. The device of claim 1, wherein at least one of the one or more storage compartments comprises:
at least one storage element configured to capture and store contaminating substances; and/or
a plurality of passive sound-producing elements configured such that when a flow of water enters the respective storage compartment through the plurality of holes, the flow of water moves the plurality of passive sound-producing elements causing contacts between them, thereby producing a sound.

18. (canceled)

19. The device of claim 1, further comprising a connect configured to attach the device to an auxiliary subaquatic structure external to the device.

20. (canceled)

21. A method of using a shield device, comprising:
a) a primary wall configured as a front outer wall comprising at least one curved surface;
b) a secondary wall comprising at least a flat surface, defining one or more internal compartments arranged between the primary wall and the secondary wall; comprising said one or more internal compartments respective end portions configured to be partially free of said primary and secondary walls; and
c) a container structure comprising one or more walls forming one or more storage compartments,
wherein said shield device is configured as a material comprising calcium carbonate for use in the proliferation of underwater biodiversity.
